(19) United States
(12) Patent Application Publication
(10) Pub. No.: US 2016/0177859 A1
(43) Pub. Date: Jun. 23, 2016

(54) METHOD OF OPERATING AN INTERNAL COMBUSTION ENGINE

(71) Applicant: GM GLOBAL TECHNOLOGY OPERATIONS LLC, Detroit, MI (US)

(72) Inventors: Luca GATTI, Deruta (PG) (IT); Chiara POZZI, Ceres (TO) (IT); Giorgio NATI, Villar Focchiardo (TO) (IT); Davide Francesco MERCURI, Torino (IT); Luca CHIAPUSSO, Torino (IT)

(73) Assignee: GM GLOBAL TECHNOLOGY OPERATIONS LLC, Detroit, MI (US)

(21) Appl. No.: 14/967,468

(22) Filed: Dec. 14, 2015

(30) Foreign Application Priority Data
Dec. 18, 2014 (GB) 1422613.8

(51) Int. Cl. F02D 41/30; F02D 41/02

(52) U.S. Cl. CPC F02D 41/3076; F02D 41/0255

(57) ABSTRACT

A method of operating an internal combustion engine is described, which includes executing a warm up strategy of an engine aftertreatment system, wherein the warm up strategy includes injecting fuel into the engine according to a multi-injection pattern having at least one after injection.

### CROSS-REFERENCE TO RELATED APPLICATION

This application claims priority to Great Britain Patent Application No. 1422613.8, filed Dec. 18, 2014, which is incorporated herein by reference in its entirety.

### TECHNICAL FIELD

The present disclosure pertains to a method of operating an internal combustion engine, typically an internal combustion engine of a motor vehicle, such as a diesel engine or a gasoline engine. More specifically, the present disclosure relates to a method of operating the internal combustion engine in order to quickly and effectively warm up an engine aftertreatment system.

### BACKGROUND

It is known that modern internal combustion engines are equipped with an aftertreatment system comprising one or more aftertreatment devices which are disposed in the exhaust pipe to change the composition of the exhaust gases, thereby reducing the polluting emissions of the engine.

Some examples of aftertreatment devices include catalytic converters (two and three ways), oxidation catalysts, lean NOₓ traps, hydrocarbon adsorbers, selective catalytic reduction (SCR) systems, and particulate filters.

In order to reduce the emissions of nitrogen oxides (NOₓ), some internal combustion engines may be also equipped with an exhaust gas recirculation (EGR) system, which is provided for routing back part of the exhaust gas produced by the engine from the exhaust manifold into the intake manifold.

Many aftertreatment devices are generally characterized by a so called “light off” temperature, below which the efficiency of these aftertreatment devices is quite low and they are not always able to achieve the emission reduction targets required by the current legislations.

This side effect particularly occurs when the aftertreatment devices are aged due a prolonged use, so that it is generally necessary to try to prevent this performance reduction by correspondently increasing the quantity of Platinum Group Metals (PGM) inside the aftertreatment devices.

In addition, it is generally necessary to try to accelerate as much as possible the warm up of the aftertreatment devices by overusing other devices capable of heating the engine, such as for example the glow plugs that are conventionally located in the engine cylinders.

### SUMMARY

In view of the above, in accordance with embodiments of the present disclosure provided are strategies for warming up the aftertreatment system of an engine, which are capable of reducing the time necessary for the aftertreatment devices to reach their light off temperature, thereby allowing both new and aged devices to meet the emission reduction targets more effectively.

Advantageously provided by the herein described embodiments, the goal is reached with a simple, rational and rather inexpensive solution.

More particularly, an embodiment of the invention provides a method of operating an internal combustion engine executing a warm up strategy of an engine aftertreatment system, wherein the warm up strategy may include injecting fuel into the engine according to a multi-injection pattern including at least one after injection.

An after injection is an injection of fuel that is performed inside the engine cylinder after the piston has passed the top death center (TDC) position but before the opening of the exhaust valve. The quantity of fuel supplied by means of an after injection, which is normally a small quantity (e.g. 1 mm³), has a negligible impact on the torque generated by the engine but actually burns inside the cylinder, thereby increasing the temperature of the exhaust gases that, after the opening of the exhaust valve, will flow through the aftertreatment system.

In this ways, the overheated exhaust gas increases the temperature of the aftertreatment system, whose devices can thus reach faster the light off temperature and become quickly efficient even when they are aged.

By reducing the warm up time, the proposed strategy has also the advantages of preventing other components (such as the glow plugs) from being overused and of allowing the adoption of aftertreatment devices having a reduced quantity of Platinum Group Metals (PGM), thereby achieving an overall reduction of the cost related to the aftertreatment system.

In addition, the combustion of the fuel provided by the after injection attains also a faster warm up of the engine bodies, such as the engine block and the cylinder head, along with all the engine fluids that circulates inside them, such as the engine coolant and engine lubricant, thereby achieving other secondary benefits.

For example, by accelerating the engine coolant warm up, the proposed strategy makes it possible to heat faster the cabin of the vehicle, thereby increasing the comfort for the driver and the passengers especially when they use the vehicle under very cold environmental conditions.

According to an aspect of the invention, the multi-injection pattern may include a plurality of after injections (e.g. up to four after injections per engine cycle).

By using a plurality of after injections (i.e. a multi-after-injection pattern) instead of a single after injection, all the benefits mentioned above can be enhanced and favorably optimized.

In addition, a multi-after-injection pattern is capable of supporting the combustion within the engine cylinder, thereby reducing the production of hydrocarbon (HC) and obtaining a better stability of the engine.

According to another aspect of the invention, the multi-injection pattern may include at least one post injection.

A post injection is an injection of fuel that is performed inside the engine cylinder after the opening of the exhaust valve. The quantity of fuel supplied by means of a post injection, which is normally a small quantity (e.g. 1 mm³), does not burn inside the cylinder but is discharged unburnt through the exhaust valve. As a matter of fact, this quantity of fuel burns along the exhaust line or within the oxidation catalyst (e.g. DOCs) on its path, thereby locally producing hot exhaust gases that are able to heat the aftertreatment system.

By using at least one post injection, the proposed strategy is thus able to warm up also aftertreatment devices that are located relatively far from the engine, such as selective catalytic reduction (SCR) catalysts.

An aspect of the invention provides that the multi-injection pattern may include a plurality of post injections.

By using a plurality of post injections (i.e. a multi-post-injection pattern) instead of a single post injection, the benefit mentioned above can be enhanced.

According to another aspect of the invention, the warm up strategy may further comprise allowing a recirculation of exhaust gas from an exhaust manifold to an intake manifold of the engine.

Thanks to this aspect of the invention, while the fuel injection is performed according to the multi-injection pattern disclosed above, it is also possible to reduce the amount of nitrogen oxides (NOₓ) produced by the engine, thereby contributing to reduce the polluting emission even during the execution of the warm up strategy.

An aspect of the invention provides that the warm up strategy may be executed if (i.e. only if) an exhaust gas temperature at an inlet of a particulate filter of the aftertreatment system is below a predetermined threshold value thereof.

This aspect makes it possible to activate the warm up strategy only if the aftertreatment system is actually cold.

Another aspect of the invention provides that the warm up strategy may be executed if (i.e. only if) an engine coolant temperature is below a predetermined threshold value thereof.

This aspect makes it possible to activate the warm up strategy only if the engine is actually cold.

Still another aspect of the invention provides that the warm up strategy may be executed if (i.e. only if) an engine speed is below a predetermined threshold value thereof.

This aspect of the invention is based on the fact that, when the engine speed exceeds a given threshold value, the temperature of the exhaust gas produced by the engine is generally high enough to effectively heat the aftertreatment system, without the need of performing after injections and/or post injections. As a consequence, this aspect of the invention has the effect of preventing an unnecessary consumption of fuel.

According to another aspect of the invention, the warm up strategy may be executed if (i.e. only if) an engine load (e.g. the quantity of fuel globally injected per engine cycle) is below a predetermined threshold value thereof.

This aspect of the invention is based on the fact that, when the engine load exceeds a given threshold value, the temperature of the exhaust gas produced by the engine is generally high enough to effectively heat the aftertreatment system, without the need of performing after injections and/or post injections. As for the preceding case, also this aspect of the invention has thus the effect of preventing an unnecessary consumption of fuel.

Another aspect of the invention provides that the warm up strategy may be executed if (i.e. only if) a predetermined gear of an engine gear box is engaged.

This aspect of the invention provides an additional degree of freedom that allows to activate the warm up strategy only if it is strictly needed to raise the temperature of the aftertreatment system.

According to still another aspect of the invention, the warm up strategy may be executed if (i.e. only if) an ambient pressure and an ambient temperature are both below a predetermined threshold value thereof.

This aspect allows to activate the warm up strategy only if the engine is operated under environmental conditions that actually requires for the aftertreatment system to be heated.

A further aspect of the invention provides that the warm up strategy may be deactivated after a predetermined time after its activation.

This aspect allows to achieve a favorable trade-off between the warm up speed and the fuel consumption.

The method of the invention can be carried out with the help of a computer program comprising a program-code for carrying out the method described above, and in the form of a computer program product comprising the computer program. The method can be also embodied as an electromagnetic signal, said signal being modulated to carry a sequence of data bits which represent a computer program to carry the method.

Another embodiment of the invention provides an internal combustion engine equipped with an electronic control unit configured to execute a warm up strategy of an engine aftertreatment system, wherein the warm up strategy comprises injecting fuel into the engine according to a multi-injection pattern including at least one after injection.

This embodiment of the invention achieves the same benefits disclosed in relation to the method, in particular that of allowing the aftertreatment devices of the aftertreatment system to reach faster their light off temperature and become quickly efficient even when they are aged.

According to an aspect of the invention, the multi-injection pattern may include a plurality of after injections (e.g. up to four after injections per engine cycle).

By using a plurality of after injections (i.e. a multi-after-injection pattern) instead of a single after injection, all the benefits mentioned above can be enhanced and favorably optimized, while obtaining also a reduction in the production of hydrocarbon (HC) and a better stability of the engine.

According to another aspect of the invention, the multi-injection pattern may include at least one post injection.

By using at least one post injection, it is possible to warm up also aftertreatment devices that are located relatively far from the engine, such as selective catalytic reduction (SCR) catalysts.

An aspect of the invention provides that the multi-injection pattern may include a plurality of post injections.

By using a plurality of post injections (i.e. a multi-post-injection pattern) instead of a single post injection, the benefit mentioned above can be enhanced.

According to another aspect of the invention, the warm up strategy may further comprise allowing a recirculation of exhaust gas from an exhaust manifold to an intake manifold of the engine.

According to this embodiment, while the fuel injection is performed according to the multi-injection pattern disclosed above, it is also possible to reduce the amount of nitrogen oxides (NOₓ) produced by the engine.

An aspect of the invention provides that the electronic control unit may be configured to execute the warm up strategy if (i.e. only if) an exhaust gas temperature at an inlet of a particulate filter of the aftertreatment system is below a predetermined threshold value thereof.

This aspect makes it possible to activate the warm up strategy only if the aftertreatment system is actually cold.

Another aspect of the invention provides that the electronic control unit may be configured to execute the warm up strategy if (i.e. only if) an engine coolant temperature is below a predetermined threshold value thereof.

This aspect makes it possible to activate the warm up strategy only if the engine is actually cold.

Still another aspect of the invention provides that the electronic control unit may be configured to execute the warm up strategy if (i.e. only if) an engine speed is below a predetermined threshold value thereof.

This aspect of the invention has the effect of preventing an unnecessary consumption of fuel.

According to another aspect of the invention, the electronic control unit may be configured to execute the warm up strategy if (i.e. only if) an engine load (e.g. the quantity of fuel globally injected per engine cycle) is below a predetermined threshold value thereof.

Also this aspect of the invention has the effect of preventing an unnecessary consumption of fuel.

Another aspect of the invention provides that the electronic control unit may be configured to execute the warm up strategy if (i.e. only if) a predetermined gear of an engine gear box is engaged.

This aspect of the invention provides an additional degree of freedom that allows to activate the warm up strategy only if it is strictly needed to raise the temperature of the aftertreatment system.

According to still another aspect of the invention, the electronic control unit may be configured to execute the warm up strategy if (i.e. only if) an ambient pressure and an ambient temperature are both below a predetermined threshold value thereof.

This aspect allows to activate the warm up strategy only if the engine is operated under environmental conditions that actually requires for the aftertreatment system to be heated.

A further aspect of the invention provides that the electronic control unit may be configured to deactivate the warm up strategy after a predetermined time after its activation.

This aspect allows to achieve a favorable trade-off between the warm up speed and the fuel consumption.

Another embodiment of the invention provides an automotive system comprising an internal combustion engine and means for executing a warm up strategy of an engine aftertreatment system, wherein the means for executing the warm up strategy comprise means for injecting fuel into the engine according to a multi-injection pattern including at least one after injection.

This embodiment of the invention achieves the same benefits disclosed in relation to the method, in particular that of allowing the aftertreatment devices of the aftertreatment system to reach faster their light off temperature and become quickly efficient even when they are aged.

According to an aspect of the invention, the multi-injection pattern may include a plurality of after injections (e.g. up to four after injections per engine cycle).

By using a plurality of after injections (i.e. a multi-after-injection pattern) instead of a single after injection, all the benefits mentioned above can be enhanced and favorably optimized, while obtaining also a reduction in the production of hydrocarbon (HC) and a better stability of the engine.

According to another aspect of the invention, the multi-injection pattern may include at least one post injection.

By using at least one post injection, it is possible to warm up also aftertreatment devices that are located relatively far from the engine, such as selective catalytic reduction (SCR) catalysts.

An aspect of the invention provides that the multi-injection pattern may include a plurality of post injections.

By using a plurality of post injections (i.e. a multi-post-injection pattern) instead of a single post injection, the benefit mentioned above can be enhanced.

According to another aspect of the invention, the means for executing the warm up strategy may further comprise means for allowing a recirculation of exhaust gas from an exhaust manifold to an intake manifold of the engine.

Thanks to this aspect of the invention, while the fuel injection is performed according to the multi-injection pattern disclosed above, it is also possible to reduce the amount of nitrogen oxides (NOₓ) produced by the engine.

An aspect of the invention provides that the means for executing the warm up strategy may be configured to operate if (i.e. only if) an exhaust gas temperature at an inlet of a particulate filter of the aftertreatment system is below a predetermined threshold value thereof.

This aspect makes it possible to activate the warm up strategy only if the aftertreatment system is actually cold.

Another aspect of the invention provides that the means for executing the warm up strategy may be configured to operate if (i.e. only if) an engine coolant temperature is below a predetermined threshold value thereof.

This aspect makes it possible to activate the warm up strategy only if the engine is actually cold.

Still another aspect of the invention provides that the means for executing the warm up strategy may be configured to operate if (i.e. only if) an engine speed is below a predetermined threshold value thereof.

This aspect of the invention has the effect of preventing an unnecessary consumption of fuel.

According to another aspect of the invention, the means for executing the warm up strategy may be configured to operate if (i.e. only if) an engine load (e.g. the quantity of fuel globally injected per engine cycle) is below a predetermined threshold value thereof.

Also this aspect of the invention has the effect of preventing an unnecessary consumption of fuel.

Another aspect of the invention provides that the means for executing the warm up strategy may be configured to operate if (i.e. only if) a predetermined gear of an engine gear box is engaged.

This aspect of the invention provides an additional degree of freedom that allows to activate the warm up strategy only if it is strictly needed to raise the temperature of the aftertreatment system.

According to still another aspect of the invention, the means for executing the warm up strategy may be configured to operate if (i.e. only if) an ambient pressure and an ambient temperature are both below a predetermined threshold value thereof.

This aspect allows to activate the warm up strategy only if the engine is operated under environmental conditions that actually requires for the aftertreatment system to be heated.

A further aspect of the invention provides that the means for executing the warm up strategy may be configured to deactivate the warm up strategy after a predetermined time after its activation.

This aspect allows to achieve a favorable trade-off between the warm up speed and the fuel consumption.

### BRIEF DESCRIPTION OF THE DRAWINGS

The present invention will hereinafter be described in conjunction with the following drawing figures, wherein like numerals denote like elements.

FIG. 1 schematically shows an automotive system according to an embodiment of the invention.

FIG. 2 is the section A-A of an internal combustion engine belonging to the automotive system of FIG. 1.

FIG. 3 schematically shows the layout of the aftertreatment system of the automotive system of FIG. 1.

FIG. 4 schematically shows an aftertreatment system having a first alternative layout.

FIG. 5 Schematically shows an aftertreatment system having a second alternative layout.

FIG. 6 is a flowchart representing a warm up strategy for the engine and the aftertreatment system.

FIG. 7 represents a first multi-injection pattern that may be involved in the warm up strategy of FIG. 6.

FIG. 8 represents a second multi-injection pattern that may be involved in the warm up strategy of FIG. 6.

FIG. 9 is a flowchart representing an activation/deactivation logic for the warm up strategy of FIG. 6.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

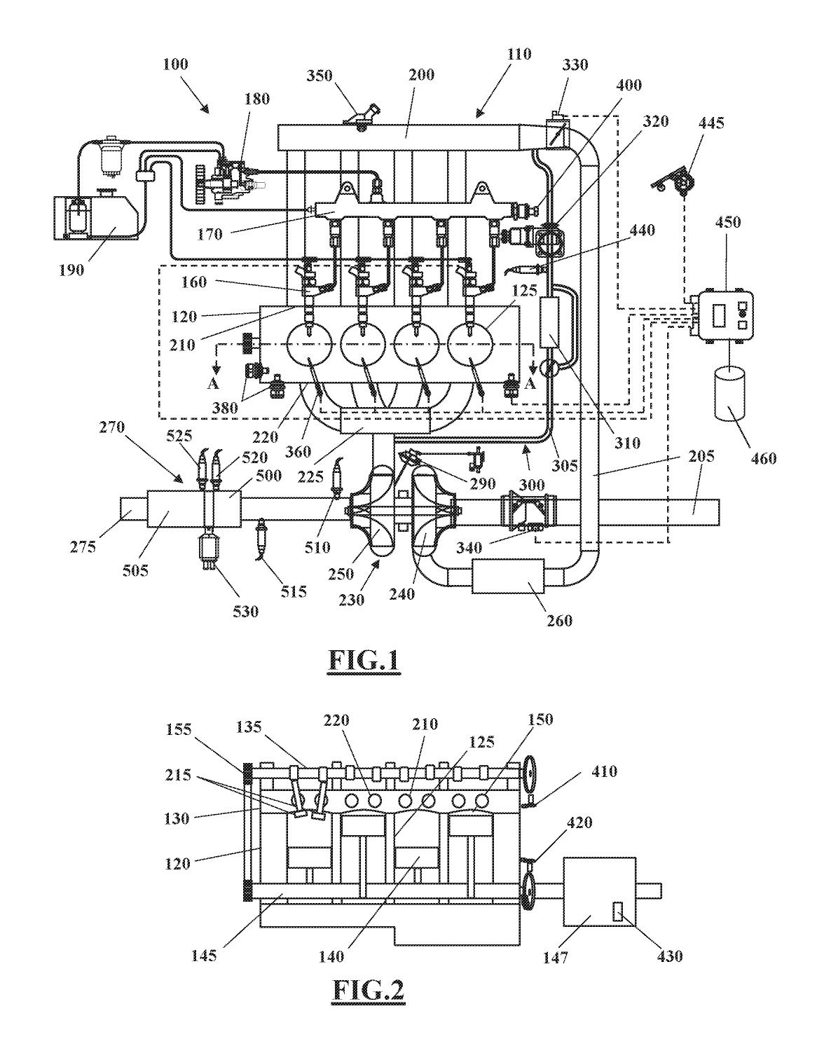

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. The crankshaft 145 may be coupled to rotate a final drive (not shown) of the automotive system 10), such as two or more drive wheels, through a gear box 147. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each one of the cylinders 125 has at least two valves 215, actuated by a camshaft 135 rotating in time with the crankshaft 145. The valves 215 selectively allow air into the combustion chamber 150 from the intake port 210 and alternately allow exhaust gases to exit through an exhaust port 220. In some examples, a cam phaser 155 may selectively vary the timing between the camshaft 135 and the crankshaft 145.

The air may be distributed to the air intake port(s) 210 through an intake manifold 200. An air intake pipe 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the intake pipe 205 and manifold 200. An intercooler 260 disposed in the intake pipe 205 may reduce the temperature of the air. The turbine 250 rotates by receiving exhaust gases from an exhaust manifold 225 that directs exhaust gases from the exhaust ports 220 and through a series of vanes prior to expansion through the turbine 250. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate valve.

Some embodiments may comprise an exhaust gas recirculation (EGR) system 300 including an EGR conduit 305 that fluidly connects the outlet of the exhaust manifold 225 with the inlet of the intake manifold 200, thereby allowing part of the exhaust gas to be mixed with the comburent air. The EGR system 300 may further include an EGR cooler 310 located in the EGR conduit 305 to reduce the temperature of the exhaust gases in the EGR system 300. An EGR valve 320 may be provided for regulating the flow rate of exhaust gases in the EGR conduit 305.

Downstream of the turbine 250, the exhaust gases are directed into an aftertreatment system 270. The aftertreatment system 270 may include an exhaust pipe 275 having one or more exhaust aftertreatment devices. The aftertreatment devices may be any device configured to change the composition of the exhaust gases. Some examples of aftertreatment devices include, but are not limited to, catalytic converters (two and three way), oxidation catalysts, lean NOₓ traps, hydrocarbon adsorbers, selective catalytic reduction (SCR) systems, and particulate filters.

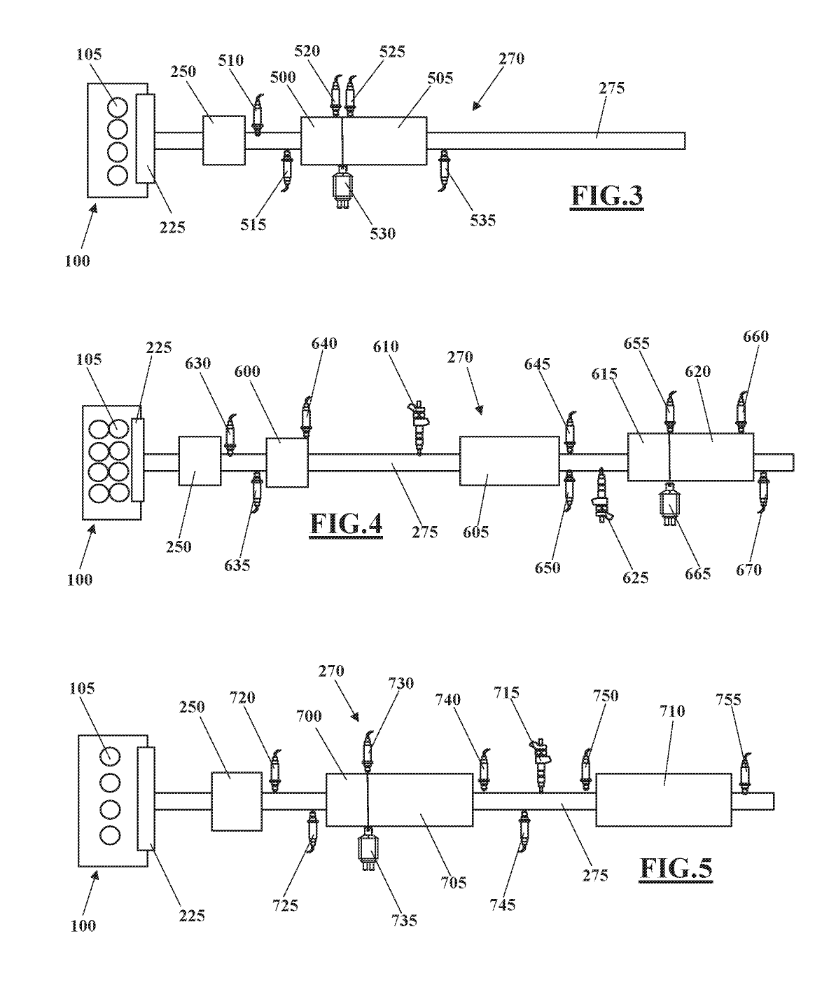

In the embodiment of FIGS. 1 and 3, the aftertreatment system 270 comprises a first catalyst 500 operating both as a lean NOₓ trap and a diesel oxidation catalyst (LNT-DOC), which is disposed in the exhaust pipe 275 in proximity of the turbine 250, and a diesel particulate filter (DPF) 505 disposed in the exhaust pipe 275 downstream of the LNT-DOC 500. The LNT-DOC 500 and the DPF 505 may be accommodated inside a common housing. A lambda sensor 510 and a temperature sensor 515 may be located in the exhaust pipe 275 between the turbine 250 and the LNT-DOC 500, in order to respectively measure the oxygen concentration and the temperature of the exhaust gas at the inlet of the LNT-DOC 500. A second lambda sensor 520 and a second temperature sensor 525 may be located in the housing between the LNT-DOC 500 and the DPF 505, in order to respectively measure the oxygen concentration and the temperature of the exhaust gas at the inlet of the DPF 505. A pressure sensor 530 may be provided for measuring the pressure drop across the DPF 505. A soot sensor 535 may be also disposed in the exhaust pipe 275 downstream of the DPF 505, in order to measure the soot concentration in the exhaust gas.

In other embodiments (specially for 8-cylinder engines), the aftertreatment system 270 may comprise a diesel oxidation catalyst (DOC) 600 located in the exhaust pipe 275 in proximity of the turbine 250, as shown in FIG. 4. A selective catalytic reduction (SCR) system may be disposed in the exhaust pipe 275 downstream of the DOC 600, which includes an SCR catalyst 605 and an injector 610 located upstream of the SCR catalyst 605. The injector 610 is provided for injecting, into the exhaust pipe 275, a diesel exhaust fluid (DEF), for example urea, which mixes with the exhaust gas and is absorbed inside the SCR catalyst 605, where it is used to convert nitrogen oxides (NOₓ) into diatomic nitrogen (N₂) and water. Downstream of the SCR catalyst 605, the aftertreatment system 270 may comprise a second DOC 615 and a DPF 620 located in the exhaust pipe 275 downstream of the DOC 615. The DOC 615 and the DPF 620 may be accommodated inside a common housing. Between the SCR catalyst 605 and the second DOC 615, an injector 625 may be provided for injecting hydrocarbons (HC) inside the exhaust pipe 275. A first NOₓ sensor 630 may be located in the exhaust pipe 275 between the turbine 250 and the first DOC 600, in order to measure the concentration of nitrogen oxides. Two temperature sensors 635 and 640 may be provided for measuring the exhaust gas temperature upstream and downstream of the first DOC 600. A second NOₓ sensor 645 and a third temperature sensor 650 may be located in the exhaust pipe 275, between the SCR catalyst 605 and the HC injector 625, in order to respectively measure the nitrogen oxides concentration and the temperature of the exhaust gas. A fourth and a fifth temperature sensor 655 and 660 may be provided for measuring the exhaust gas temperature respectively at the inlet and at the outlet of the DPF 620. A pressure sensor 665 may be provided for measuring the pressure drop across the DPF 620. A soot sensor 670 may be also located in the exhaust pipe 275 downstream of the DPF 620, in order to measure the soot concentration in the exhaust gas.

In still other embodiments, the aftertreatment system 270 may comprise a diesel oxidation catalyst (DOC) 700 located in the exhaust pipe 275 in proximity of the turbine 250 and a DPF 705 located in the exhaust pipe 275 downstream of the DOC 700, as shown in FIG. 5. The DOC 700 and the DPF 705 may be accommodated inside a common housing. A selective catalytic reduction (SCR) system may be disposed in the exhaust pipe 275 downstream of the DPF 705, which includes an SCR catalyst 710 and an DEF injector 715 located upstream of the SCR catalyst 710. A lambda sensor 720 and a temperature sensor 725 may be disposed in the exhaust pipe 275 between the turbine 250 and the DOC 700, in order to respectively measure the oxygen concentration and the temperature of the exhaust gas. A second temperature sensor 730 may be located in the common housing between the DOC 700 and the DPF 705, in order to measure the exhaust gas temperature at the inlet of the DPF 705. A pressure sensor 735 may be also provided for measuring the pressure drop across the DPF 705. A soot sensor 740 and a third temperature sensor 745 may be located in the exhaust pipe 275 between the DPF 705 and the DEF injector 715, in order to measure the soot concentration and the temperature of the exhaust gas respectively. Two NOₓ sensors 750 and 755 may be finally provided for measuring the concentration of nitrogen oxides at the inlet and the outlet of the SCR catalyst 710.

The automotive system 100 may further include an electronic control unit (ECU) 450 in communication with one or more sensors and/or devices associated with the ICE 110 (see FIG. 1). The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, a sensor 430 for sensing the gear engaged in the gear box 147, an EGR temperature sensor 440, and an accelerator pedal position sensor 445. The sensors include also all the sensor of the aftertreatment system 270 that have been mentioned above. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system 460, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the methods and control the ICE 110.

The program stored in the memory system 460 is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

One of the tasks of the ECU 450 is that of operating each fuel injectors 160, in order to supply the fuel into the corresponding combustion chamber 150. In general, for any engine cycle, the fuel injector 160 may be operated so as to perform a single fuel injection or, more often, to perform a plurality of subsequent fuel injections (also referred as injection pulses) according to a predetermined multi-injection pattern.

The multi-injection pattern usually includes a so called main fuel injection, which is performed shortly before the piston 140 reaches the top death center position (TDC) at the end of the compression stroke. The main fuel injection supplies a relatively big quantity of fuel, which is able to generate, at the crankshaft 145, a torque corresponding to the demand of the driver.

The multi-injection pattern may also comprise one or more pilot injections, which are performed during the compression stroke of the piston 140, just before the main injection. The quantity of fuel supplied by means of each pilot injection is normally a small quantity, for example of about 1 mm³ of fuel, and has the effect of reducing the explosiveness of the main injection and thus the vibration of the engine 110.

The multi-injection pattern may also comprise one or more after injections. An after injection is an injection of fuel that is performed inside the combustion chamber 150 after the piston 140 has passed the top death position (TDC) at the beginning of the expansion stroke, but before the opening of the exhaust port 220. The quantity of fuel supplied by means of an after injection, which is normally a small quantity (e.g. 1 mm³), has a negligible impact on the torque generated by the engine but burns inside the combustion chamber 150, thereby increasing the temperature of the exhaust gases that, after the opening of the exhaust port 220, will flow towards the aftertreatment system 270.

The multi-injection pattern may also comprise one or more post injections. A post injection is an injection of fuel that is performed inside the combustion chamber 150 after the opening of the exhaust port 220 at the end of the expansion stroke. The quantity of fuel supplied by means of a post injection, which is normally a small quantity (e.g. 1 mm³), does not burn inside the combustion chamber 150 but is discharged unburnt through the exhaust port 220 towards the aftertreatment system 270. As a matter of fact, this quantity of fuel may burn along the exhaust pipe 275 or within the aftertreatment devices, thereby producing hot exhaust gases that are able to locally heat such devices.

According to conventional control strategies, the ECU 450 is generally configured to perform a multi-injection pattern having after injections and post injections, only during the regeneration of the particulate filter 505 (or 620 or 705 depending on the layout of the aftertreatment system 270).

However, according to an aspect of the present disclosure, the ECU 450 may be also configured to take advantage of the heating effect of the after injections and possibly of the pilot injections, in order to speed up the warm up of the aftertreatment system 270 after the start of the engine 110 and/or under other predetermined conditions, thereby reaching faster the light off temperature of the aftertreatment devices and thus improving their efficiency.

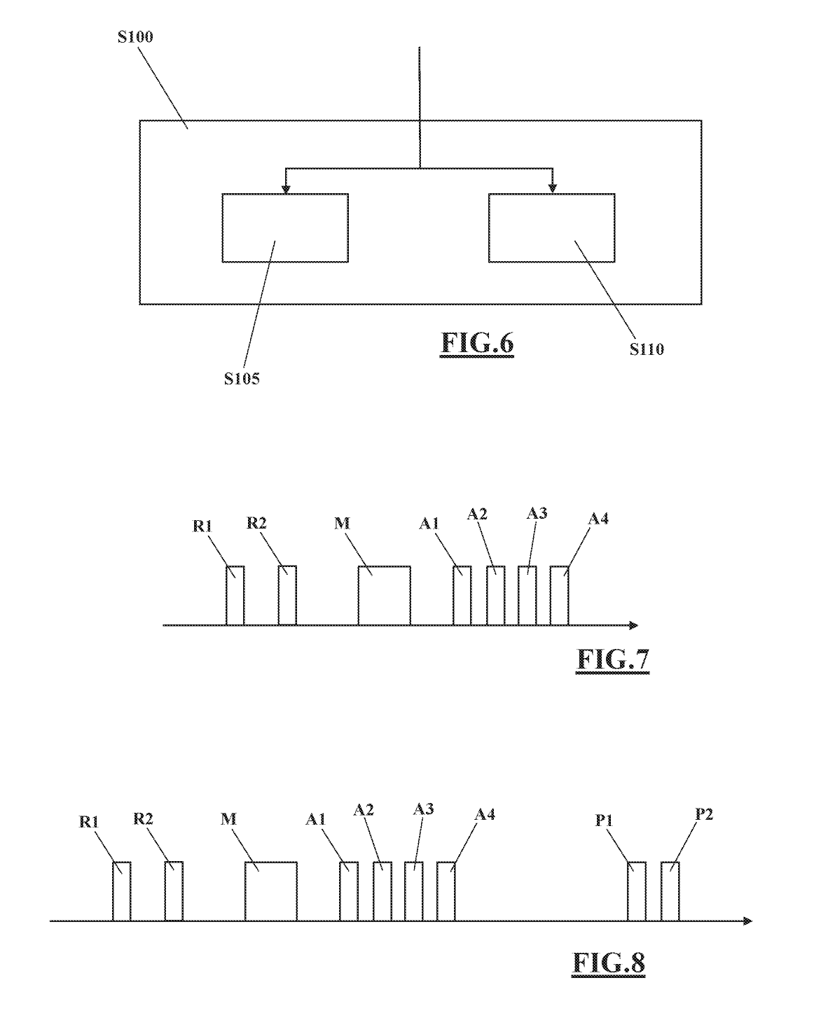

In other words, the ECU 450 may be configured to selectively activate a warm up strategy (block S100 of FIG. 6), which comprises at least injecting fuel into the engine (block S105) according to a multi-injection pattern that includes a main injection, possibly one or one pilot injections, normally not more than two pilot injections, and one or more after injections, normally not more than four after injections.

An explanatory multi-injection pattern of this kind is represented in FIG. 7, wherein the after injections are indicated as A1, A2, A3 and A4, the main injection is indicated as M and the pilot injections are indicated as R1 and R2.

Thanks to the after injections that burn inside the combustion chambers 150, the exhaust gas that exit the exhaust ports 220 is overheated and is able to increase the temperature of aftertreatment system 270, whose devices can thus reach faster the light off temperature and become quickly efficient even when they are aged.

However, since the temperature of the exhaust gas emitted by the engine 110 progressively decreases along the exhaust pipe 275, this solution is specially effective for heating the aftertreatment devices that are relatively close to the engine 110, such as the LNT-DOC 500 of the aftertreatment system 270 represented in FIG. 3, the DOC 600 of the aftertreatment system 270 of FIG. 4, or the DOC 700 of the aftertreatment system 270 of FIG. 5.

For this reason, an aspect of the present disclosure provides that the multi-injection pattern performed during the execution of the warm up strategy may also include one or more post injections, normally not more than two post injections.

An explanatory multi-injection pattern of this second kind is represented in FIG. 8, wherein the pilot injections are indicated as P1 and P2, the after injections are indicated as A1, A2, A3 and A4, the main injection is indicated as M and the pilot injections are indicated as R1 and R2.

In addition to the heating effect produced by the after injections, the quantity of fuel provided by the post injections burns along the exhaust pipe 275 and/or within the DOCs, so that the resulting exhaust gases are effectively able to heat the aftertreatment devices that are located relatively far from the engine 110, such as the SCR catalyst 605 of the aftertreatment systems 270 of FIG. 4 or the SCR catalyst 710 of the aftertreatment system 270 of FIG. 5.

While operating the fuel injection according to the multi-injection pattern disclosed above, the warm up strategy S100 may also comprise allowing a recirculation of exhaust gas from the exhaust manifold 225 to the intake manifold 200 of the engine 110 (block S110 of FIG. 6).

To obtain this recirculation, the ECU 450 may be configured to operate the EGR valve 320 in order to open at least partially the EGR conduit 305, thereby letting the exhaust gas pass therein. The quantity of recirculated exhaust gas may be regulated by the ECU 450 according to conventional strategies, in order to reduce the quantity of nitrogen oxides (NOₓ) generated by the engine 110.

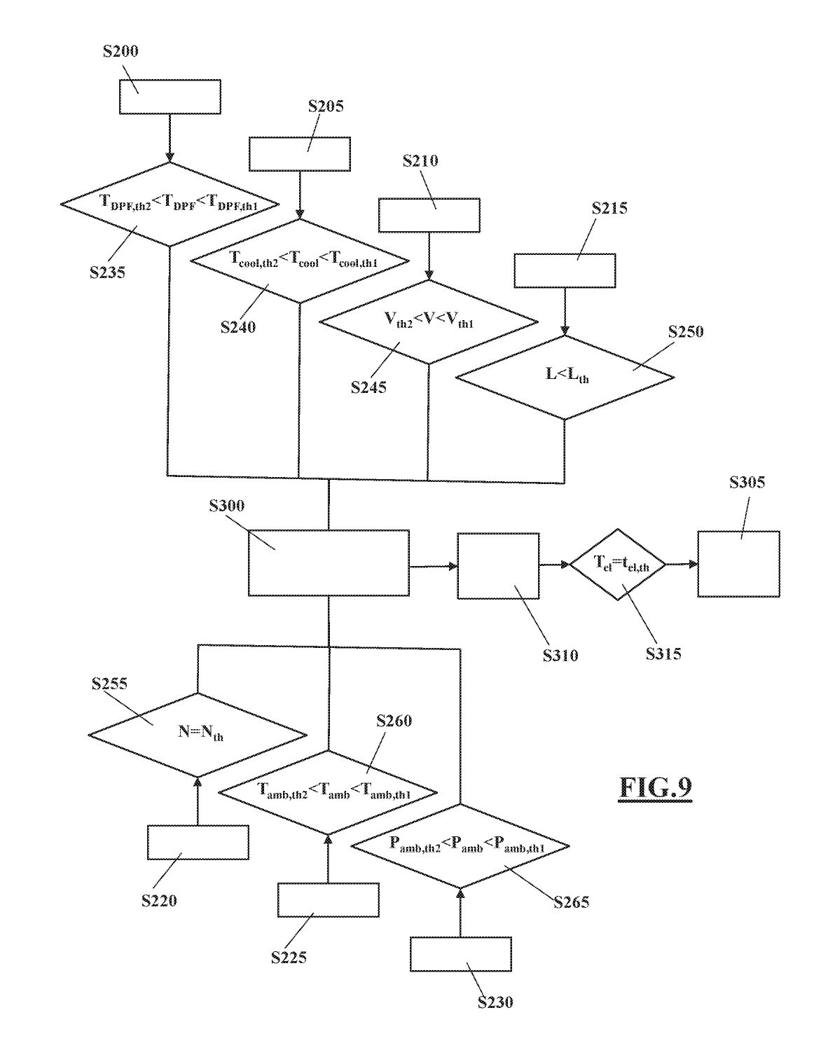

According to another aspect of the present disclosure, the warm up strategy S100 may be activated and executed only if certain predetermined conditions are fulfilled, for example according to the activation/deactivation logic represented in the flowchart of FIG. 9.

First of all, the activation/deactivation logic may provide for the ECU 450 to monitor the value of one or more engine operating parameters. In particular, the ECU 450 may be configured to monitor the value T_{DPF} of the exhaust gas temperature at the inlet of the DPF (block S200). Considering the aftertreatment system 270 of FIG. 3, the temperature T_{DPF} may be measured by means of the sensor 525. Considering the aftertreatment system 270 of FIG. 4, the temperature T_{DPF} may be measured by means of the sensor 655. Considering the aftertreatment system 270 of FIG. 5, the temperature T_{DPF} may be measured by means of the sensor 730.

The ECU 450 may be also configured to monitor the value T_{cool} of the engine coolant (block S205), for example by means of the sensor 380.

In addition, the ECU 450 may be also configured to monitor the value V of the engine speed (block S210), for example by means of the crank position sensor 420, and the value L of the engine load (block S215), namely the torque requested at the crankshaft 145 or correspondently the quantity of fuel to be injected inside the combustion chambers 150 to generate said torque. The value L of the engine load may be determined by the ECU 450 on the basis of the position of the accelerator pedal as measured by the sensor 445.

The ECU 450 may be further configured to monitor the gear N engaged in the gear box 147 (block S220), for example by means of the sensor 430, the value T_{amb} of the ambient temperature (block S225) and the value P_{amb} of the ambient pressure (block S230). The values T_{amb} and P_{amb} may be measured by the ECU 450 with dedicated sensors (not shown).

While monitoring these parameters, the ECU 450 may be configured to activate the warm up strategy (block S300) only if all the conditions set forth below are contemporaneously met.

A first condition may provide that the value T_{DPF} of the exhaust gas temperature at the inlet of the DPF is below a predetermined threshold value T_{DPF,th1} thereof (block S235). The threshold value T_{DPF,th1} may be a calibration parameter that may be determined by means of an experimental activity and/or based on theoretical considerations. By way of example, the threshold value T_{DPF,th1} may be any value lower than 250° C., in particular it may be set at 220° C. More particularly, the first condition may provide that the value T_{DPF} of the exhaust gas temperature at the inlet of the DPF is comprised between the threshold value T_{DPF,th1} and a second predetermined threshold value T_{DPF,th2}, which is lower than the first one. Also this second threshold value T_{DPF,th2} may be a calibration parameter that may be determined by means of an experimental activity and/or based on theoretical considerations. By way of example, the second threshold value T_{DPF,th2} may be set at 16° C.

A second condition may provide that the value T_{cool} of the engine coolant temperature is below a predetermined threshold value T_{cool, th1} thereof (block S240). The threshold value T_{cool,th1} may be a calibration parameter that may be determined by means of an experimental activity and/or based on theoretical considerations. By way of example, the threshold value T_{cool,th1} may be any value lower than 50° C., in particular it may be set at 40° C. More particularly, the second condition may provide that the value T_{cool} of the engine coolant temperature is comprised between the threshold value T_{cool,th1} and a second predetermined threshold value T_{cool,th2} which is lower than the first one. Also this second threshold value T_{cool,th2} may be a calibration parameter that may be determined by means of an experimental activity and/or based on theoretical considerations. By way of example, the second threshold value T_{cool,th2} may be set at 16° C.

A third condition may provide that the value V of the engine speed is below a predetermined threshold value Vₜₕ₁ thereof (block S245). The threshold value Vₜₕ₁ may be a calibration parameter that may be determined by means of an experimental activity and/or based on theoretical considerations. By way of example, the threshold value Vₜₕ₁ may be any value lower than 3000 rpm (round per minute), in particular it may be set at 2750 rpm. More particularly, the third condition may provide that the value V of the engine speed is comprised between the threshold value Vₜₕ₁ and a second predetermined threshold value Vₜₕ₂, which is lower than the first one. This second threshold value T_{DPF,th2} may correspond to the idle speed of the engine 110 and may be set for example at 850 rpm.

A fourth condition may provide that the value L of the engine load is below a predetermined threshold value Lₜₕ thereof (block S250). The threshold value Lₜₕ may be a calibration parameter that may be determined by means of an experimental activity and/or based on theoretical considerations. By way of example, the threshold value Lₜₕ may be any value comprised between 40 and 50 mm³.

A fifth condition may provide that the gear N engaged in the gearbox 147 corresponds to a predetermined one Nₜₕ (block S255). The predetermined gear Nₜₕ may be chosen on the basis of theoretical considerations. By way of example, the predetermined gear Nₜₕ may be the second gear.

A sixth condition may provide that the value T_{amb} of the ambient temperature is below a predetermined threshold value T_{amb,th1} thereof (block S260). The threshold value T_{amb,th1} may be a calibration parameter that may be determined by means of an experimental activity and/or based on theoretical considerations. By way of example, the threshold value T_{amb,th1} may be any value lower than 40° C., in particular it may be set at 32° C. More particularly, the sixth condition may provide that the value T_{amb} of the ambient temperature is comprised between the threshold value T_{amb,th1} and a second predetermined threshold value T_{amb,th2}, which is lower than the first one. Also this second threshold value T_{amb,th2} may be a calibration parameter that may be determined by means of an experimental activity and/or based on theoretical considerations. By way of example, the second threshold value T_{amb,th2} may be set at 16° C.

An seventh condition may provide that the value P_{amb} of the ambient pressure is below a predetermined threshold value P_{amb,th1} thereof (block S265). The threshold value P_{amb,th1} may be a calibration parameter that may be determined by means of an experimental activity and/or based on theoretical considerations. By way of example, the threshold value P_{amb,th1} may be any value lower than 110 KPa, in particular it may be set at 105 KPa. More particularly, the seventh condition may provide that the value P_{amb} of the ambient pressure is comprised between the threshold value P_{amb,th1} and a second predetermined threshold value P_{amb,th2}, which is lower than the first one. Also this second threshold value P_{amb,th2} may be a calibration parameter that may be determined by means of an experimental activity and/or based on theoretical considerations. By way of example, the second threshold value P_{amb,th2} may be set at 91 KPa.

Once the warm up strategy has been activated, it may be executed as long as all the above mentioned conditions are still fulfilled. As soon as at least one of the conditions is no more fulfilled, the warm up strategy may be deactivated (block S305) and the engine 110 may be operated according to conventional fuel injection strategies. By way of example, the warm up strategy may be deactivated when the value T_{DPF} of the exhaust gas temperature at the DPF inlet exceeds the threshold value T_{DPF,th1} or when the value T_{cool} of the engine coolant temperature exceeds the threshold value T_{cool,th1}, because it generally means that the aftertreatment system 270 and/or the engine 110 has/have been already warmed up.

In addition or as an alternative, a timer (block S310) may be provided for counting the time tₑ₁ that elapses from the activation of the warm up strategy. In this way, the warm up strategy may be deactivated as soon as said time tₑ₁ reaches a predetermined value t_{e1,th} thereof (block S315). The threshold value t_{e1,th} may be a calibration parameter that may be determined by means of an experimental activity and/or based on theoretical considerations, in order to achieve a favourable trade-off between the warm up speed and the fuel consumption. By way of example, the threshold value t_{e1,th} may be any value lower than 50 s (seconds), in particular it may be set at 35 s.

Even if the preceding disclosure provides that the warm up strategy is activated and executed only if all the conditions set forth above are satisfied, other embodiments may provide for the warm up strategy to be activated and executed when only one (or a limited group) of said conditions is satisfied. By way of example, the warm up strategy may be activated and executed provided that only the first condition (related to the exhaust gas temperature) and/or the second condition (related to the coolant temperature) is/are satisfied.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A method of operating an internal combustion engine comprising executing a warm up strategy of an engine aftertreatment system, wherein the warm up strategy comprises injecting fuel into the engine according to a multi-injection pattern including at least one after injection.

17. A method according to claim 16, wherein the multi-injection pattern includes a plurality of after injections.

18. A method according to claim 16, wherein the multi-injection pattern includes at least one post injection.

19. A method according to claim 18, wherein the multi-injection pattern includes a plurality of post injections.

20. A method according to claim 16, wherein the warm up strategy comprises allowing a recirculation of exhaust gas from an exhaust manifold to an intake manifold of the engine.

21. A method according to claim 16, wherein the warm up strategy is executed if an exhaust gas temperature at an inlet of a particulate filter of the aftertreatment system is below a predetermined threshold value thereof.

22. A method according to claim 16, wherein the warm up strategy is executed if an engine coolant temperature is below a predetermined threshold value thereof.

23. A method according to claim 16, wherein the warm up strategy is executed if an engine speed is below a predetermined threshold value thereof.

24. A method according to claim 16, wherein the warm up strategy is executed if an engine load is below a predetermined threshold value thereof.

25. A method according to claim 16, wherein the warm up strategy is executed if a predetermined gear of an engine gear box is engaged.

26. A method according to claim 16, wherein the warm up strategy is executed if an ambient pressure and an ambient temperature are both below a predetermined threshold value thereof.

27. A method according to claim 16, wherein the warm up strategy is deactivated after a predetermined time after its activation.

28. A computer program comprising a program-code for carrying out a method according to claim 16.

29. A computer program product comprising the computer program of claim 28.

30. An internal combustion engine equipped with an electronic control unit configured to execute a warm up strategy of an engine aftertreatment system, wherein the warm up strategy comprises injecting fuel into the engine according to a multi-injection pattern including at least one after injection.
